(19) United States
(12) Patent Application Publication
(10) Pub. No.: US 2024/0296113 A1
(43) Pub. Date: Sep. 5, 2024

(54) AUTOMATED INTEGRATION AND TEST SYSTEM OF SYSTEM ON CHIP (SOC) PRODUCT

(71) Applicant: REALTEK SEMICONDUCTOR CORP., Hsinchu (TW)

(72) Inventors: Yan-Ping Chen, Suzhou (CN); Yan Guo, Suzhou (CN); Chun-Xia Guo, Suzhou (CN)

(73) Assignee: REALTEK SEMICONDUCTOR CORP., Hsinchu (TW)

(21) Appl. No.: 18/230,868

(22) Filed: Aug. 7, 2023

(30) Foreign Application Priority Data
Mar. 1, 2023 (CN) 202310186533.2

(51) Int. Cl. G06F 11/36

(52) U.S. Cl. CPC G06F 11/3696; G06F 11/3688

(57) ABSTRACT

An automated integration and test system includes a host server and a plurality of working stations. The host server is configured to execute: reviewing submitted code so as to obtain a review result; compiling the submitted code so as to obtain a compiling result in response to that the review result indicates “pass”; obtaining a compiled code in response to that the compiling result indicates “success”; and actuating one or more working stations to execute an item to be tested so as to obtain a full test result.

### CROSS-REFERENCE TO RELATED APPLICATION

This non-provisional application claims priority under 35 U.S.C. § 119(a) to Patent Application No. 202310186533.2 filed in China on Mar. 1, 2023, the entire contents of which are hereby incorporated by reference.

### BACKGROUND

### Technical Field

The instant disclosure is related to a test system, especially an automated integration and test system of system on chip (SOC) products.

### Related Art

Development processes of purely software products known to the inventor have automated integrated test functions, but such test functions do not include hardware control and testing. In general, the development and testing process of system on chip (SOC) products are separated: that is, after the development of software is completed, code compiling and burning will be carried out on a development board, and then manual testing will be carried out. This process costs more time, and the iteration of versions is slow. Besides, the quality control (QC) is done manually, and therefore the efficiency of the QC is lower.

### SUMMARY

In view of these, some embodiments of the instant disclosure integrate software development and hardware testing process and provide an automated control and test system of SOC products. Each submission of code triggers a corresponding integrated test which is automatically carried out by a computer, where the computer automatically carries out the test by controlling the SOC hardware products. Therefore, problems appearing in the version in development can be discovered in real time during code submission stage and thus faulty codes can be prevented from being merged with normal codes. At the same time, some embodiments of the instant disclosure realize sharing of a single set of hardware environment. As a result, developers do not need to rebuild testing environments locally; instead, the developers can directly utilize the system in place of manual labor to perform multiple stress tests on the product in development. Therefore, cost and time (24 hours a day) for performing multiple stress tests on the product in development can be reduced. Furthermore, Expensive testing equipment thus can be replaced with algorithms to analyze test results such as audio signals, human voices, etc., and the implementation of simultaneous deployment of multiple devices for testing can be achieved much easier.

In some embodiments of the instant disclosure, an automated integration and test system comprises a host server and a plurality of working stations. The host server is configured to execute: reviewing a submitted code so as to obtain a review result; compiling the submitted code so as to obtain a compiling result in response to that the review result indicates “pass”; obtaining a complied code in response to that the compiling result indicates “success,” wherein the complied code comprises an item to be tested, and the item to be tested is at least one selected from the group consisting of a modular test and a functional test; and actuating at least one of the working stations to execute the item to be tested so as to obtain a full test result.

In some embodiments, the host server is further configured to execute; sending the review result to a code source end in response to that the review result indicates “not pass”; sending the compiling result to the code source end in response to that the compiling result indicates “not success”; marking the submitted code as “can be merged” in response to that the full test result indicates “pass”; and merging the submitted code into a full code in response to that the full test result indicates “pass”.

In some embodiments, the host server determines that the full test result indicates “not pass” in response to that at least one of the functional test and the modular test (i.e., the functional test and/or the modular test) does not pass a testing.

In some embodiments, each of the working stations comprises a slave server, a development board, a control board, and a test sensing device. The slave server sends a test command to the development board according to the compiled code so that the development board generates a response. The test command is at least one selected from the group consisting of a first control command and a second control command, and the second control command is sent to the development board through the control board. The test sensing device sends the response of the development board to the slave server.

In some embodiments, the automated integration and test system is used for functional testing of a Bluetooth product.

As above, some embodiments of the instant disclosure provide a system able to perform automated control and testing on SOC products. Therefore, manual labor for performing multiple stress tests on a product in development can be replaced, and thus cost and time can be saved.

### BRIEF DESCRIPTION OF THE DRAWINGS

The instant disclosure will become more fully understood from the detailed description given herein below for illustration only, and therefore not limitative of the instant disclosure, wherein:

FIG. 1 illustrates a schematic block diagram of an automated integration and test system and a code source end according to an embodiment of the instant disclosure;

FIG. 2 illustrates a schematic block diagram of a host server according to an embodiment of the instant disclosure;

FIG. 3 illustrates a schematic block diagram of a working station according to an embodiment of the instant disclosure; and

FIG. 4 illustrates a schematic flow chart of an operation of the host server according to an embodiment of the instant disclosure.

### DETAILED DESCRIPTION

The foregoing and other technical contents, features, and effects of the instant disclosure can be clearly presented below in detailed description with reference to embodiments of the accompanying drawings. Thicknesses or sizes of the elements in the drawings illustrated in an exaggerated, omitted, or general manner are used to help a person skilled in the art with comprehension and reading, and the sizes of the elements are not completely the actual sizes and are not intended to limit any restraint conditions under which the instant disclosure can be implemented and therefore have no technical significance. Any modification to the structures, change to the proportional relationships, or adjustment on the sizes without affecting the effects and objectives that can be achieved according to the instant disclosure should fall within the scope of the technical content disclosed by the instant disclosure. In all drawings, identical symbols are used to denote identical or similar elements.

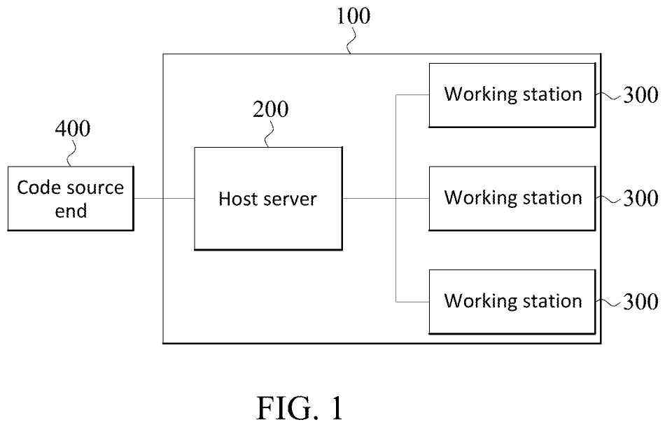

FIG. 1 illustrates a schematic block diagram of an automated integration and test system 100 and a code source end 400 according to an embodiment of the instant disclosure. Please refer to FIG. 1. The automated integration and test system 100 is configured to perform review and testing on submitted codes. The automated integration and test system 100 integrates software development and hardware testing and can automatically perform control and testing on SOC products. Each submission of code triggers the integrated test, and the integrated test is completely and automatically performed by a computer, where the computer automatically performs the integrated test by controlling the SOC hardware products. Therefore, problems appearing in the version in development can be discovered in real time during code submission stage and thus faulty codes can be prevented from being merged with normal codes. In the embodiment shown in FIG. 1, the submitted code comes from the code source end 400 external to the automated integration and test system 100, but the instant disclosure is not limited thereto; the submitted code may also come from a file which is pre-saved in a memory of a host server 200.

The automated integration and test system 100 comprises a host server 200 and a plurality of working stations 300. The host server 200 is directly connected or indirectly coupled to each of the working stations 300. The host server 200 is configured to generate a complied code based on the submitted code and send the compiled code to one or more of the working stations 300. The working stations 300 which receive the compiled code are each configured to perform a test on the compiled code so as to obtain a full test result. The full test result can be returned (sent back) to the host server 200 or saved in a memory. In some embodiments, the host server 200 is implemented using Jenkins server, but the instant disclosure is not limited thereto. In some embodiments, the host server 200 utilizes Gerrit software or other software able to perform code organization and/or allocation to perform organization and/or allocation on the submitted code.

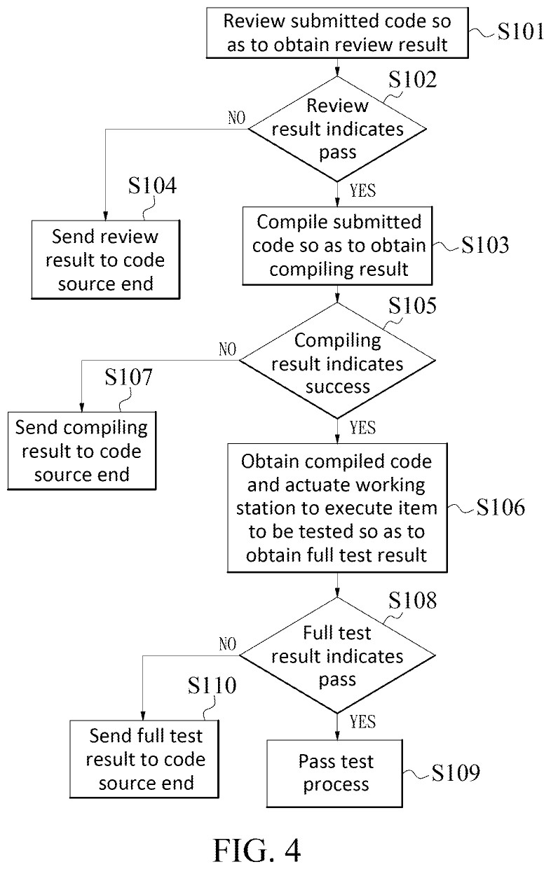

Please also refer to FIG. 4. FIG. 4 illustrates a schematic flow chart of an operation of the host server 200 according to an embodiment of the instant disclosure. Specifically, in this embodiment, in the step S101, the host server 200 first reviews the submitted code (such as through Defensics, Black Duck, or other code reviewing tools) so as to obtain a review result. Then, the host server 200 executes the step S102 to determine whether the review result indicates “pass”. In response to that the review result indicates “pass”, the host server 200 executes the step S103 so as to compile the submitted code and obtain a compiling result. Then, the host server 200 executes the step S105 to determine whether the compiling result indicates “success”. Next, in response to that the compiling result is determined to indicate “success” in the step S105, the host server 200 executes the step S106 so as to obtain a compiled code and actuate at least one of the working stations 300 to execute an item to be tested and obtain the full test result. Then, the host server 200 executes the step S108 to determine whether the full test result indicates “pass”. The compiled code comprises an item to be tested (i.e., the item to be tested mentioned in the step S106). The item to be tested is a modular test (e.g., I/O test, platform test, protocol stack test, and frame test) and/or a functional test, and the modular test and/or functional test may each be more than one type of test. For example, the item to be tested may comprise one or more modular tests, comprise one or more functional tests, or comprise one or more modular tests and one or more functional tests. The host server 200 selectively actuates the working stations 300 to perform the modular tests and/or the functional tests according to a file of the submitted code. If the item to be tested merely comprises a single modular test or a single functional test, the host server 200 may selectively and merely actuate a single working station 300 to execute the item to be tested. If the item to be tested comprises multiple tests, the host server 200 may selectively actuate a single working station 300 to execute the item to be tested or actuate multiple working stations 300 to execute the item to be tested in a synchronized manner or a multiplexed manner. Besides, the working stations 300 may also be selectively divided into functional test working stations and modular test working stations. In some embodiments, in response to that at least one of the functional test and the modular test (i.e., the functional test and/or the modular test) did not pass the testing, the host server 200 determines that the full test result indicates “not pass”. Next, in response to that the full test result is determined to indicate “pass” in the step S108, the host server 200 executes the step S109. In the step S109, the host server 200 determines that the submitted code passes the test process, and the host server 200 marks the submitted code as “can be merged” and/or merges the submitted code into a full code. If the review result is determined to indicate “not pass” in the step S102, the host server 200 executes the step S104 so as to return the review result to the code source end 400. If the compiling result is determined to indicate “not success” in the step S105, the host server 200 executes the step S107 so as to return the compiling result to the code source end 400. If the full test result is determined to indicate “not pass” in the step S108, the host server 200 executes the step S110 so as to return the full test result to the code source end 400. In some embodiments, when the full test result indicates “not pass”, the result indicating “not pass” is not directly returned to the code source end 400 but is reported to a bug tracking system. The bug tracking system may be but is not limited to JIRA.

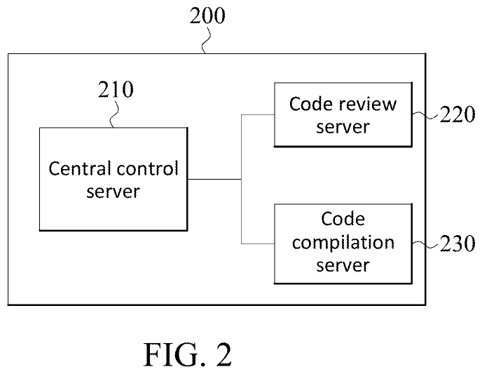

Please also refer to FIG. 2. FIG. 2 illustrates a schematic block diagram of the host server 200 according to an embodiment of the instant disclosure. In some embodiments, the host server 200 comprises a plurality of servers, and each of the servers is configured to execute one or multiple functions (such as central control, code reviewing, code compiling, or combinations comprising any two or more thereof). For example, in an embodiment, the host server 200 comprises a central control server 210, a code review server 220, and a code compilation server 230. In this embodiment, the central control server 210 is in charge of allocating a destination of the submitted code/the review result/the compiling result/the compiled code/the full test result (such as to send this information to the code review server 220, the code compilation server 230, one of the working stations 300, or JIRA); in response to that the full test result indicates “pass”, the central control server 210 also marks the submitted code as “can be merged” and/or merges the submitted code to the full code. Besides, the code review server 220 is in charge of reviewing the submitted code and generating the review result, and the code compilation server 230 is in charge of compiling the submitted code so as to generate the compiled code and generate the compiling result. Alternatively, in some embodiments, the host server 200 may also send the submitted code to one or more external servers, and the external servers which receive the submitted code execute the aforementioned steps individually or in a complexed manner so as to generate the complied code.

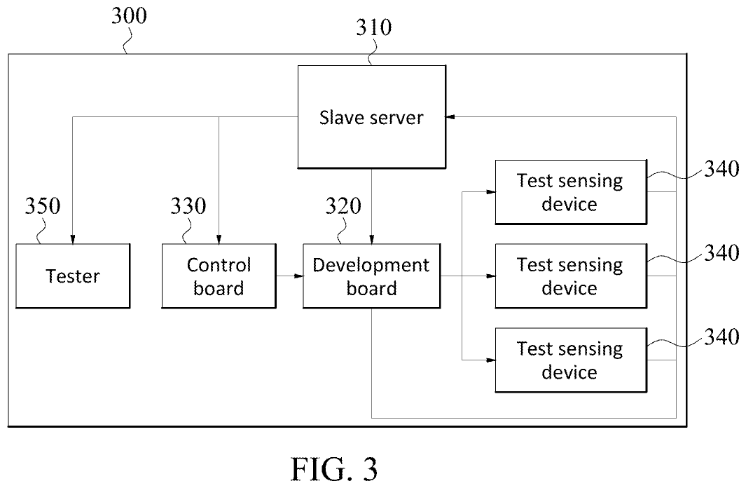

FIG. 3 illustrates a schematic block diagram of a working station 300 according to an embodiment of the instant disclosure. Please refer to FIG. 1 through FIG. 3. Each of the working stations 300 comprises a slave server 310 and a development board 320. The slave server 310 is configured to send one or more test commands to the development board 320 according to the compiled code, so that the development board 320 generates a response. The test command may, for example, perform low level testing on the product in development on the development board 320 through a serial port (the test command sent through the serial port may be referred to as a first control command). Next, the host server 200 shown in FIG. 1 or FIG. 2 then obtains the full test result according to the response of the development board 320.

In some embodiments, one or more of the working stations 300 each further comprise a control board 330 and a test sensing device 340. In these embodiments, the slaver server 310 selectively or alternatively sends one or more test commands to the development board 320 through the control board 330 so as to perform a user operation test on the product in development on the development board 320 (the test command sent through the control board 330 may be referred to as a second control command). In other words, in these embodiments, the slave server 310 sends the first control command to the development board 320 according to the compiled code, and/or the slave server 310 sends the second control command to the development board 320 through the control board 330. The product in development on the development board 320 generates the response in correspondence to the low level testing indicated by the first control command and/or the user operation test indicated by the second control command. The test sensing device 340 sends the response of the development board 320 to the slave server 310. Specifically, in some embodiments, the entirety of the testing process may be divided into the following steps: (1) performing a reset button operation on the SOC product through the control board 330 so as to emulate a manual power-on reset; (2) checking an operation log of the SOC so as to check various statuses of the SOC and whether an allocation of resource conforms to expectation; (3) sending a command through a general purpose input/output (GPIO) of the control board 330 and directly (such as through a serial port) by the slave server 310 so as to control the SOC product and emulate a manual operation; and (4) checking an operation log of the SOC and an output of an external device (the test sensing device 340) so as to determine whether a behavior of the SOC product conforms to the expectation through various test statistics. The above steps are not limited to being executed in such order. For example, the automated integration and test system 100 may be used for a functional test of a Bluetooth product. Taking an example in which the produce in development on the development board 320 is a pair of Bluetooth earbuds, the user operation test may be opening/closing a lid of a charging box, taking/putting the Bluetooth earbuds out of/in the charging box, increasing/decreasing a volume, answering/hanging up a phone call, playing/pausing, previous/next track, etc. or combinations comprising any two or more thereof. The number of the test sensing devices 340 may be one or multiple, and the test sensing device 340 is configured to sense the response of the development board 320, such as an audio playback, an audio synchronization, and an amplitude of current.

In some embodiments, one or more of the working stations 300 further comprise a tester 350. The tester 350 may receive the control command from the slave server 310 (e.g., the tester 350 is controlled through a software tool), or the user may manually operate the tester 350 so as to emulate the manual operation. The tester 350 generates a response based on the received control command or manual operation. The response of the tester 350 may be taken as a reference to be compared with the response of the development board 320, so as to inspect the functions of the compiled code in the hardware in development. For example, the product in development on the development board 320 and the tester 350 may both be Bluetooth earbuds or Bluetooth speakers. Alternatively, in some embodiments, the tester 350 may be used to test an interaction or a connection of the product in development on the development board 320 with an external device. For example, the product in development on the development board 320 may be a pair of Bluetooth earbuds or a Bluetooth speaker, and the tester 350 may be a smart phone or a notebook computer.

Furthermore, depending on demands, one or more of the working stations 300 may be set to perform a long-term stress test. For example, the slave server 310 uses an internal automated testing tool and a script to execute a combination of the above functional tests and/or modular tests or to repeatedly execute one or more functional tests and/or modular tests, so as to collect information on a response of the product in development on the development board 320 to long-time use.

As above, some embodiments of the instant disclosure provide a system able to perform automated control and testing on SOC products. Therefore, manual labor for performing multiple stress tests on a product in development can be replaced, and thus cost and time can be saved.

Although the technical context of the instant disclosure has been disclosed with the preferred embodiments above, the embodiments are not meant to limit the instant disclosure. Any adjustment and retouch done by any person skill in the art without deviating from the spirit of the instant disclosure shall be covered by the scope of the instant disclosure. Therefore, the protected scope of the instant disclosure shall be defined by the attached claims.

What is claimed is:

1. An automated integration and test system comprising:
a plurality of working stations; and
a host server configured to execute:
reviewing a submitted code so as to obtain a review result;
compiling the submitted code so as to obtain a compiling result in response to that the review result indicates “pass”;
obtaining a complied code in response to that the compiling result indicates “success,” wherein the complied code comprises an item to be tested, and the item to be tested is at least one selected from the group consisting of a modular test and a functional test; and
actuating at least one of the working stations to execute the item to be tested so as to obtain a full test result.

2. The automated integration and test system according to claim 1, wherein the host server determines that the full test result indicates “not pass” in response to that at least one of the functional test and the modular test does not pass a testing.

3. The automated integration and test system according to claim 1, wherein the host server is further configured to execute: sending the review result to a code source end in response to that the review result indicates “not pass”.

4. The automated integration and test system according to claim 3, wherein the host server determines that the full test result indicates “not pass” in response to that at least one of the functional test and the modular test does not pass a testing.

5. The automated integration and test system according to claim 3, wherein the host server is further configured to execute: sending the compiling result to the code source end in response to that the compiling result indicates “not success”.

6. The automated integration and test system according to claim 5, wherein the host server determines that the full test result indicates “not pass” in response to that at least one of the functional test and the modular test does not pass a testing.

7. The automated integration and test system according to claim 5, wherein the host server is further configured to execute: sending the full test result to the code source end in response to that the full test result indicates “not pass”.

8. The automated integration and test system according to claim 7, wherein the host server determines that the full test result indicates “not pass” in response to that at least one of the functional test and the modular test does not pass a testing.

9. The automated integration and test system according to claim 1, wherein the host server is further configured to execute: marking the submitted code as “can be merged” in response to that the full test result indicates “pass”.

10. The automated integration and test system according to claim 9, wherein the host server determines that the full test result indicates “not pass” in response to that at least one of the functional test and the modular test does not pass a testing.

11. The automated integration and test system according to claim 1, wherein the host server is further configured to execute: merging the submitted code into a full code in response to that the full test result indicates “pass”.

12. The automated integration and test system according to claim 11, wherein the host server determines that the full test result indicates “not pass” in response to that at least one of the functional test and the modular test does not pass a testing.

13. The automated integration and test system according to claim 1, wherein each of the working stations comprises a slave server and a development board, and the slave server is configured to execute:
sending a test command to the development board according to the compiled code so that the development board generates a response;
wherein the test command is at least one selected from the group consisting of a first control command and a second control command; and
wherein the host server obtains the full test result according to the response of the development board.

14. The automated integration and test system according to claim 13, wherein each of the working stations further comprises a control board and at least one test sensing device, the second control command is sent to the development board through the control board, the test sensing device sends the response of the development board to the slave server, and the automated integration and test system is used for functional testing of a Bluetooth product.

15. The automated integration and test system according to claim 1, wherein:
the host server is further configured to execute:
sending the review result to a code source end in response to that the review result indicates “not pass”;
sending the compiling result to the code source end in response to that the compiling result indicates “not success”;
sending the full test result to the code source end in response to that the full test result indicates “not pass”;
marking the submitted code as “can be merged” in response to that the full test result indicates “pass”; and
merging the submitted code into a full code in response to that the full test result indicates “pass”;
each of the working stations comprises a slave server, a development board, a control board, and at least one test sensing device, wherein:
the slave server sends a test command to the development board according to the compiled code so that the development board generates a response, wherein the test command is at least one selected from the group consisting of a first control command and a second control command, and the second control command is sent to the development board through the control board;
the test sensing device sends the response of the development board to the slave server; and
wherein the host server obtains the full test result according to the response of the development board; and
the automated integration and test system is used for functional testing of a Bluetooth product.
